(19) United States
(12) Patent Application Publication
(10) Pub. No.: US 2011/0296437 A1
(43) Pub. Date: Dec. 1, 2011

(54) METHOD AND APPARATUS FOR LOCKLESS COMMUNICATION BETWEEN CORES IN A MULTI-CORE PROCESSOR

(76) Inventors: Devendra Raut, Cupertino, CA (US); Jayant Kotalwar, Sunnyvale, CA (US)

(21) Appl. No.: 12/790,355

(22) Filed: May 28, 2010

(51) Int. Cl. G06F 9/54

(52) U.S. Cl. 719/314

(57) ABSTRACT

A lockless processor core communication capability is provided herein. The lockless communication capability enables lockless communication between cores of a multi-core processor. Lockless communication between a first core and a second core of a multi-core processor is provided using a message queuing mechanism. The message queuing mechanism includes a message queue, a first bitmap, and a second bitmap. The message queue includes a plurality of messages configured for storing data queued by the first core for processing by the second core. The first bitmap includes a plurality of bit positions associated with respective messages of the message queue, and is configured for use by the first core to indicate availability of respective queued message data. The second bitmap includes a plurality of bit positions associated with the respective messages of the message queue, and is configured for use by the second core to acknowledge availability of the respective queued message data and to indicate reception of the respective queued message data.

### FIELD OF THE INVENTION

The invention relates generally to multi-core processors and, more specifically but not exclusively, to communication between cores of a multi-core processor.

### BACKGROUND

In a multi-core processor, there is a need for individual cores to communicate with each other. In existing multi-core processors, the cores of the processor communicate with each other using a locking mechanism or an interrupt mechanism. Disadvantageously, however, such mechanisms negatively impact the performance of multi-core processors.

### SUMMARY

Various deficiencies in the prior art are addressed by embodiments for enabling lockless communication between cores of a multi-core processor.

In one embodiment, an apparatus includes a plurality of processor cores including a first core and a second core, and a message queuing mechanism configured for enabling lockless communication between the first and second cores.

In one embodiment, a method for supporting communication between a first core and a second core of a multi-core processor includes a step of communicating data from the first core to the second core using a message queuing mechanism.

In at least some such embodiments, the message queuing mechanism includes a message queue, a first bitmap and a second bitmap. The message queue includes a plurality of messages configured for storing data queued by the first core for processing by the second core. The first bitmap includes a plurality of bit positions associated with respective messages of the message queue, and is configured for use by the first core to indicate availability of respective queued message data. The second bitmap includes a plurality of bit positions associated with the respective messages of the message queue, and is configured for use by the second core to acknowledge availability of the respective queued message data and to indicate reception of the respective queued message data.

### BRIEF DESCRIPTION OF THE DRAWINGS

The teachings herein can be readily understood by considering the following detailed description in conjunction with the accompanying drawings, in which:

FIG. 1 depicts a high-level block diagram of an exemplary multi-core processor including a plurality of processor cores;

FIG. 2 depicts one embodiment of a message queuing mechanism for use by a management core and one fast path (FP) core of the multi-core processor of FIG. 1;

FIG. 3 depicts an exemplary use of the message queuing mechanism of FIG. 2 for supporting communication between the management core and one FP core of the multi-core processor of FIG. 1;

FIG. 4 depicts one embodiment of a method for using the message queuing mechanism of FIG. 2 for supporting communication between the management core and one FP core of the multi-core processor of FIG. 1; and

FIG. 5 depicts a high-level block diagram of a computer suitable for use in performing various functions described herein.

To facilitate understanding, identical reference numerals have been used, where possible, to designate identical elements that are common to the figures.

### DETAILED DESCRIPTION OF THE INVENTION

A lockless processor core communication capability is depicted and described herein.

The lockless processor core communication capability enables lockless communication between processor cores of a multi-core processor. The communication between processor cores of a multi-core processor is lockless in that the lockless processor core communication capability obviates the need for processor cores of a multi-core processor to execute lock and unlock operations on a message queue supporting communication between the processor cores in order to perform operations (e.g., operations such as write, read, and the like) on the message queue supporting communication between the processor cores (e.g., a processor core writing to the message queue is not required to execute a lock operation on the message queue before writing to the message queue and, similarly, is not required to execute an unlock operation on the message queue after writing to the message queue; a processor core reading from the message queue is not required to execute a lock operation on the message queue before reading from the message queue and, similarly, is not required to execute an unlock operation on the message queue after reading from the message queue; and so forth).

The lockless processor core communication capability may be utilized within any suitable multi-core processor of any suitable system (e.g., packet processing devices for use in high-speed communication networks, video servers, and the like) and, therefore, it will be appreciated that the lockless processor core communication capability depicted and described herein is not intended to be limited to use in any particular type of multi-core processor or to use in any particular type of system within which multi-core processors may be used.

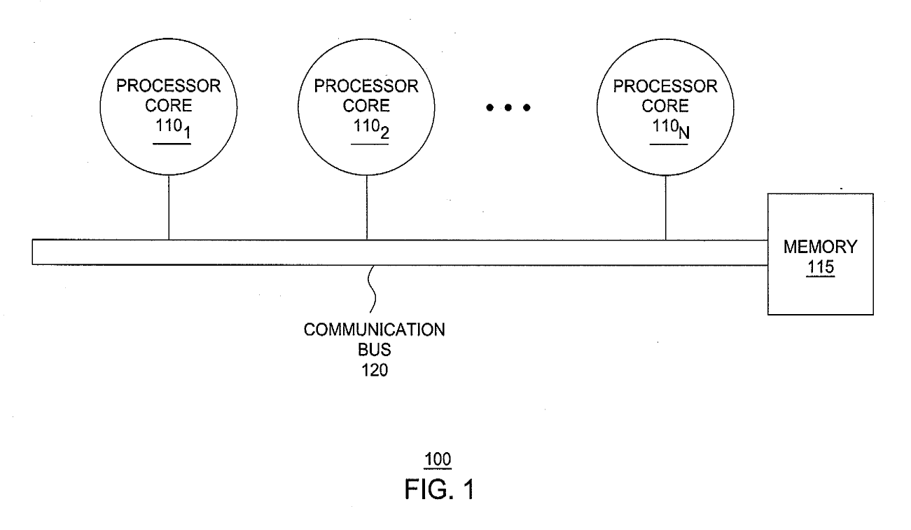

FIG. 1 depicts a high-level block diagram of an exemplary multi-core processor including a plurality of processor cores.

The multi-core processor 100 includes a plurality of processor cores 110₁-110_{N} (collectively, processor cores 110).

The multi-core processor 100 may include any suitable number (N) of processor cores 110 (e.g., 2 cores, 4 cores, 6 cores, 16 cores, 32 cores, 64 cores, and the like).

In one embodiment, the processor core 110₁ is a management core configured for providing management functions for multi-core processor 110, and the processor cores 110₂-110_{N} are fast path (FP) cores forming a fast path (FP) of multi-core processor 110. The management core manages the FP cores. The management core sends, to the FP, requests or commands requiring processing. The management core queues the requests and commands for processing by the FP cores. The FP cores, after processing the data queued by the management core, may provide processing results back to the management core. The typical roles of a management core and associated FP cores in a multi-core processor will be understood by one skilled in the art.

The multi-core processor 110 includes a memory 115. The memory 115 may be any suitable memory. For example, memory 115 may be a Level 2 (L2) cache memory or any other suitable type of memory.

The processor cores 110 and memory 115 each are coupled to a communication bus 120 via which the processor cores 110 may communicate with each other and, further, via which each of the processor cores 110 may communicate with memory 115. Although primarily depicted and described with respect to use of a bus topology for supporting communication between processor cores 110, it will be appreciated that any other suitable topology may be used for supporting communication between processor cores 110.

As described herein, the multi-core processor 100, including the lockless processor core communication capability, enables lockless communication between the management core and the FP cores. In one embodiment, the lockless processor core communication capability is provided using message queuing mechanisms. In one such embodiment, a respective message queuing mechanism is provided for each of the FP cores, thereby enabling lockless communication from the management core to each of the FP cores. In this embodiment, multi-core processor 100 includes N−1 message queuing mechanisms associated with the N−1 FP cores that are being managed by the management core.

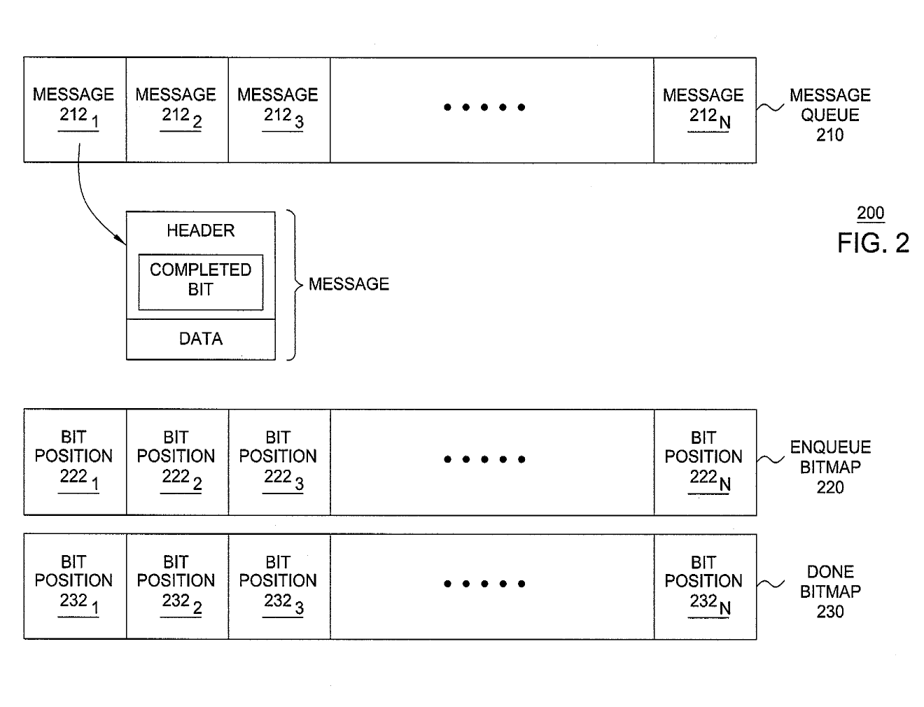

FIG. 2 depicts one embodiment of a message queuing mechanism for use by the management core and one FP core of the multi-core processor of FIG. 1.

As described herein, the message queuing mechanism 200 facilitates lockless communication between the management core and one of the FP cores of the multi-core processor 100 of FIG. 1. For purposes of clarity in describing the message queuing mechanism 200, the message queuing mechanism 200 is described within the context of facilitating communications between management core 110₁ and FP core 110₂ of multi-core processor 100 of FIG. 1.

As depicted in FIG. 2, message queuing mechanism 200 includes a message queue 210, an enqueue bitmap 220, and a done bitmap 230.

The message queue 210 enables communication of data between management core 110₁ and FP core 110₂. The message queue 210 is configured for storing data to be communicated from the management core 110₁ to the FP core 110₂ for processing by the FP core 110₂.

The message queue 210 includes a plurality of messages 212₁-212_{N} (collectively, messages 212). The messages 212 are configured for storing data to be communicated from the management core 110₁ to the FP core 110₂ for processing by the FP core 110₂. The messages 212 of message queue 210 also may store data processing results to be communicated from FP core 110₂ to management core 110₁.

As depicted in FIG. 2, each of the messages 212 of message queue 210 includes a message header portion and a message data portion.

The message header portion of each message 212 is configured for storing header information. In one embodiment, the message header portion of each message 212 includes a bit, denoted herein as a “completed” bit, which is used for supporting lockless communication between management core 110₁ and FP core 110₂. The completed bit of a message 212 supports two states, including a first state (which also may be denoted as an unset state) and a second state (which also may be denoted as a set state). In one embodiment, the completed bit is deemed to be unset when its value is zero (0) and is deemed to be set when its value is one (1). The completed bits of the messages 212 are unset by the management core 110₁ and set by the FP core 110₂. The completed bit of a message 212 is used by management core 110₁ in order to check whether or not use of that message 212, by the FP core 110₂, is complete. The completed bit of a message 212 remains in the unset state until being changed to the set state by the FP core 110₂ when the FP core 110₂ has completed processing of the data stored within the message 212. The completed bit of a message 212 is then changed from the set state back to the unset state by management core 110₁ as part of the process for releasing that message 212 (i.e., to indicate the availability of that message 212 for storing new data to be queued by management core 110₁). The message header of a message 212 may or may not include information in addition to the completed bit.

The message data portion of each message 212 is configured for storing data queued by management core 110₁ for processing by FP core 110₂. The message data portion of each message 212 is an available region of memory that is allocated for use in storing data queued by management core 110₁ for processing by FP core 110₂. In this manner, prior to queuing of data within a message 212, the message data portion of message 212 is empty (i.e., it is a region of memory available for storing data).

The data that may be queued within messages 212 by management core 110₁ for processing by FP core 110₂ may include any data that may be communicated between management core 110₁ and FP core 110₂. For example, the message data of a message 212 may include data written into the message 212 by the management core 110₁ for processing by the FP core 110₂, data written into the message 212 by the management core 110₁ for processing by the FP core 110₂ and associated instructions written into the message 212 by the management core 110₁ use by the FP core 110₂ in processing the data written into the message 212, instructions written into the message 212 by the management core 110₁ for instructing the FP core 110₂ to perform certain processing functions, and the like, as well as various combinations thereof. It will be appreciated that the types of data queued within messages 212 of message queue 210 may vary depending on various factors, e.g., the type of application for which the multi-core processor is used, the configuration of the cores of the multi-core processor, and the like, as well as various combinations thereof.

The message queue 210 is allocated within memory accessible to the management core 110₁ and the FP core 110₂. The message queue 210 may be allocated in any suitable manner. In one embodiment, for example, the message queue 210 may be a contiguous block of memory partitioned into fixed size messages. In one embodiment, for example, the message queue 200 may be a pre-allocated single linked list. The message queue 210 may be allocated in any other suitable manner. It will be appreciated that, independent of the manner in which the message queue 210 is physically implemented within memory, the management core 110₁ and FP core 110₂ each know the locations of the respective messages 212 of the message queue 210 within the physical memory (or at least have information sufficient to determine those locations when needed), such that the management core 110₁ and FP core 110₂ each may access any of the messages 212 of the message queue 210 for writing data to and reading data from the messages 212 of the message queue 210, as well as performing any other operations associated with communication of data between management core 110₁ and FP core 110₂ using message queuing mechanism 200.

The enqueue bitmap 220 is controlled by the management core 110₁, and may be read by both the management core 110₁ and the FP core 110₂. The enqueue bitmap 220 includes a plurality of bit positions 222₁-222_{N} (collectively, bit positions 222) associated with the plurality of messages 212₁-212_{N} of message queue 210, respectively. The bit positions 222₁-222_{N} store a respective plurality of bits. The bits of enqueue bitmap 220 each support two states, including a first state (which also may be denoted as an unset state) and a second state (which also may be denoted as a set state). In one embodiment, a bit of a bit position 222 is deemed to be unset when its value is zero (0) and is deemed to be set when its value is one (1). The enqueue bitmap 220 is configured for use by the management core 110₁ to indicate availability of respective queued message data. The enqueue bitmap 220 is used by the management core 110₁ in order to identify available messages 212 within message queue 210 (e.g., available for use by management core 110₁ in writing data into the message queue 210) and, similarly, to indicate availability of messages 212 for storing new data to be queued by management core 110₁ upon release of messages 212 by FP core 110₂. The enqueue bitmap 220 is used by the FP core 110₂ in order to determine whether or not data is available from the associated messages 212 of message queue 210. The enqueue bitmap 220 also may be used by the management core 110₁ and/or the FP core 110₂ for other determinations. Initially, all of the bits in the enqueue bitmap 220 are unset, thereby indicating that all of the associated messages 212 of message queue 210 are available for communicating data between management core 110₁ and FP core 110₂. When data is written into a message 212 of message queue 210 by management core 110₁, the bit of the corresponding bit position 222 in enqueue bitmap 220 is changed, by the management core 110₁, from the unset state to the set state for indicating to the FP core 110₂ that data has been queued within that message 212 for processing by the FP core 110₂. When the FP core 110₂ has finished processing data of a message 212 of message queue 210, the bit of the corresponding bit position 222 in enqueue bitmap 220 is changed, by management core 110₁, from the set state to the unset state as part of the process for releasing that message 212 (i.e., to indicate the availability of that message 212 for storing new data to be queued by management core 110₁).

The done bitmap 230 is controlled by the FP core 110₂, and may be read by both the FP core 110₂ and the management core 110₁. The done bitmap 230 includes a plurality of bit positions 232₁-232_{N} (collectively, bit positions 232) associated with the plurality of messages 212₁-212_{N} of message queue 210, respectively. The bit positions 232₁-232_{N} store a respective plurality of bits. The bits of done bitmap 230 each support two states, including a first state (which also may be denoted as an unset state) and a second state (which also may be denoted as a set state). In one embodiment, a bit of a bit position 232 is deemed to be unset when its value is zero (0) and is deemed to be set when its value is one (1). The done bitmap 230 is configured for use by the FP core 110₂ to acknowledge availability of respective queued message data and to indicate reception of the respective queued message data. The done bitmap 230 is used by the FP core 110₂ to indicate, to management core 110₁, that processing of data of messages 212 by FP core 110₂ is complete. Similarly, the done bitmap 230 is used by the management core 110₁ in order to identify messages 212 within the message queue 210 for which processing by FP core 110₂ is complete, such that the management core 110₁ may release the messages 212 (i.e., to indicate the availability of that message 212 for storing new data to be queued by management core 110₁). The done bitmap 230 also may be used by the management core 110₁ and/or the FP core 110₂ for other determinations. Initially, all bits in the done bitmap 230 are set. When data is read from a message 212 of message queue 210 by FP core 110₂, the bit of the corresponding bit position 232 in done bitmap 230 is changed by FP core 110₂ from the set state to an unset state, thereby indicating to management core 110₁ that processing of the data of the message 212 is not complete. When processing of the data of a message 212 of message queue 210 is completed by FP core 110₂, the bit of the corresponding bit position 232 in done bitmap 230 is changed by FP core 110₂ from the unset state back to the set state, thereby indicating to management core 110₁ that processing of the data of the message 212 by FP core 110₂ is complete.

The various elements of message queuing mechanism 200 may be maintained in any suitable memory (e.g., memory 115 and/or any other memory accessible to management core 110₁ and/or FP core 110₂ as needed).

The message queuing mechanism 200 is configured for use by the management core 110₁ to perform a message write operation. In order to write data into the message queue 210, the management core 110₁ searches for an available message 212 of message queue 210. The management core 110₁ identifies an available message 212 using the enqueue bitmap 220. The management core 110₁ identified an available message 212 by searching the enqueue bitmap 220 for a free bit (i.e., an unset bit). Upon finding a free bit in the enqueue bitmap 220, the management core 110₁ writes data into the message 212 of message queue 210 that is associated with the free bit of the enqueue bitmap 220. The management core also unsets the completed bit in the message header of the message 212, and sets the corresponding bit (associated with that message 212 of the message queue 210) in the enqueue bitmap 220. At this point, ownership of this message 212 in message queue 210 is passed to FP core 110₂, such that the management core 110₁ cannot write into this message 212 of message queue 210 (rather, the management core can only read from this message 212 of message queue 210).

The message queuing mechanism 200 is configured for use by FP core 110₂ to perform a message read operation. The FP core 110₂ monitors the message queue 210, the enqueue bitmap 220, and the done bitmap 230. When FP core 110₂ determines that, for a given message 212 of the message queue 210, the associated bit in the done bitmap 230 is set, the associated bit in the enqueue bitmap 220 is set, and the completed bit of the message 212 is unset, the FP core 110₂ knows that the message 212 is storing data that has been queued by the management core 110₁ for processing by FP core 110₂. The FP core 110₂ reads the message 212, or at least the data portion of the message 212, for accessing the data queued by the management core 110₁ for processing by FP core 110₂. The FP core 110₂ may copy the message 212, or at least the data portion of the message 212, to a memory location for processing (e.g., to memory 115, to a cache dedicated for use by FP core 110₂, and the like, as well as various combinations thereof). The FP core 110₂ also keeps track of the bit position associated with the message 212 (e.g., the position of the message 212 within message queue 210 and, thus, the positions of the associated bits within enqueue bitmap 220 and done bitmap 230), and unsets the associated bit in the done bitmap 230. The message queuing mechanism 200 is configured for use by FP core 110₂ to perform a message complete operation. When the FP core 110₂ completes the processing of the data of a message 212, the FP core 110₂ communicates the associated message processing results to the management core 110₁. The FP core 110₂, which at this time owns the associated message 212 of the message queue 210, sets the associated bit of the done bitmap 230 and sets the completed bit in the header of the message, thereby indicating to the management core 110₁ that processing of the data that was queued in that message 212 of the message queue 210 is complete.

The message queuing mechanism 200 is configured for use by the management core 110₁ to perform a message release operation. The management core 110₁ monitors the message queue 210, the enqueue bitmap 220, and the done bitmap 230. When the management core 110₁ determines that, for a given message 212 of message queue 210, the associated bit in the enqueue bitmap 220 is set, the associated bit in the done bitmap 230 is set, and the completed bit of the message 212 is set, the management core 110₁ knows that processing of the data queued in that message 212 of message queue 210 is complete. The management core 110₁ then unsets the associated bit in the enqueue bitmap 220, thereby making that message 212 of the message queue 210 available for queuing new data for processing.

Although primarily depicted and described herein with respect to embodiments in which the completed bits associated with messages 212 are stored as part of header portions of the respective messages 212, in other embodiments the completed bits may be stored without being included as part of header portions of the respective messages 212. In one such embodiment, for example, the completed bits associated with messages 212 may be maintained in an additional completed bit bitmap that is maintained and used in a manner similar to the enqueue bitmap 220 and the done bitmap 230 depicted and described herein.

Although primarily depicted and described with respect to use of the message queuing mechanism 200 for supporting communications between the management core 110₁ and the FP core 110₂, it will be appreciated that the multi-core processor 100 may include respective message queuing mechanisms 200 for each of the FP cores 110₂-110_{N}, thereby facilitating communication between management core 110₁ and each of the FP cores 110₂-110_{N}.

Although primarily depicted and described herein with respect to embodiments of the message queuing mechanism 200 in which an unset bit is a bit having a value of zero (0) and a set bit is a bit having a value of one (1), it will be appreciated that the message queuing mechanism 200 also may be implemented such that an unset bit is a bit having a value of one (1) and a set bit is a bit having a value of zero (0).

Although primarily depicted and described herein within the context of bits of bit positions being set and being unset, it will be appreciated that the bits of the bit positions also may be considered to have states associated therewith. For example, bits set to a value of zero (0) may be considered to be in a first state and bits set to a value of one (1) may be considered to be in a second state, and vice versa.

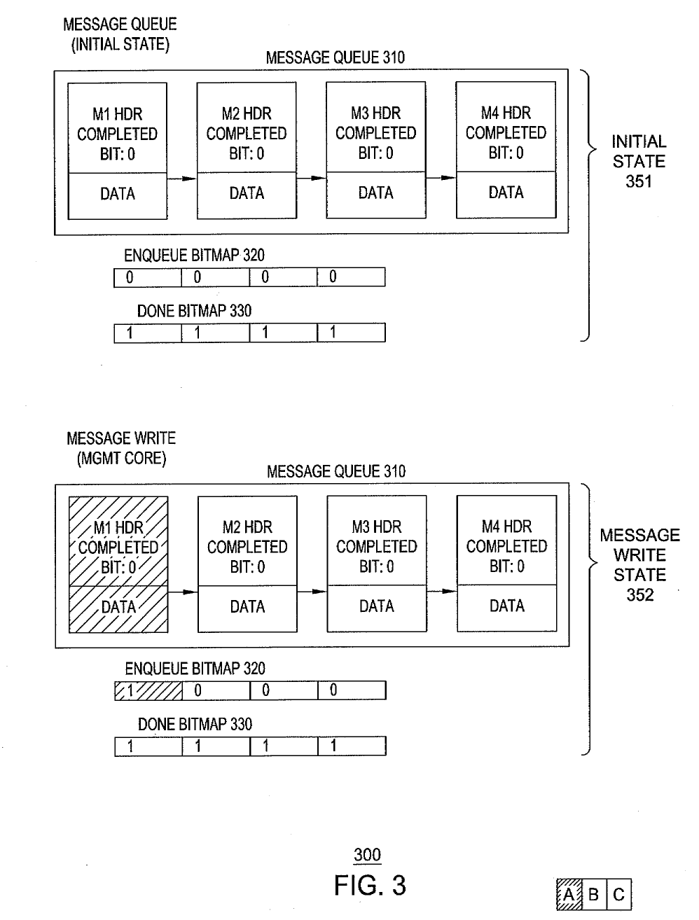

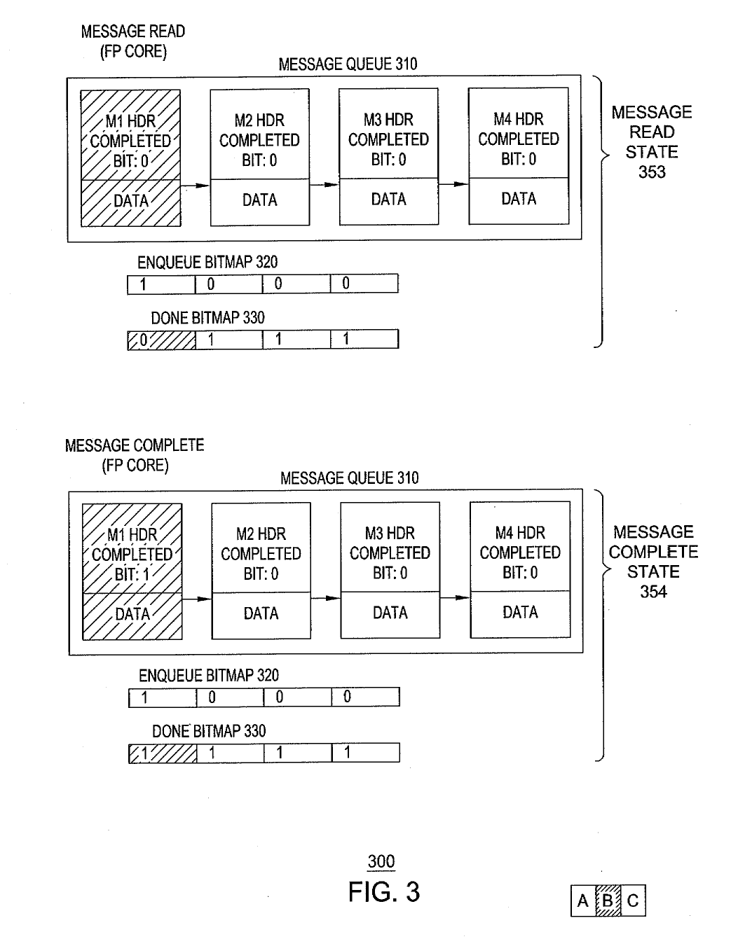

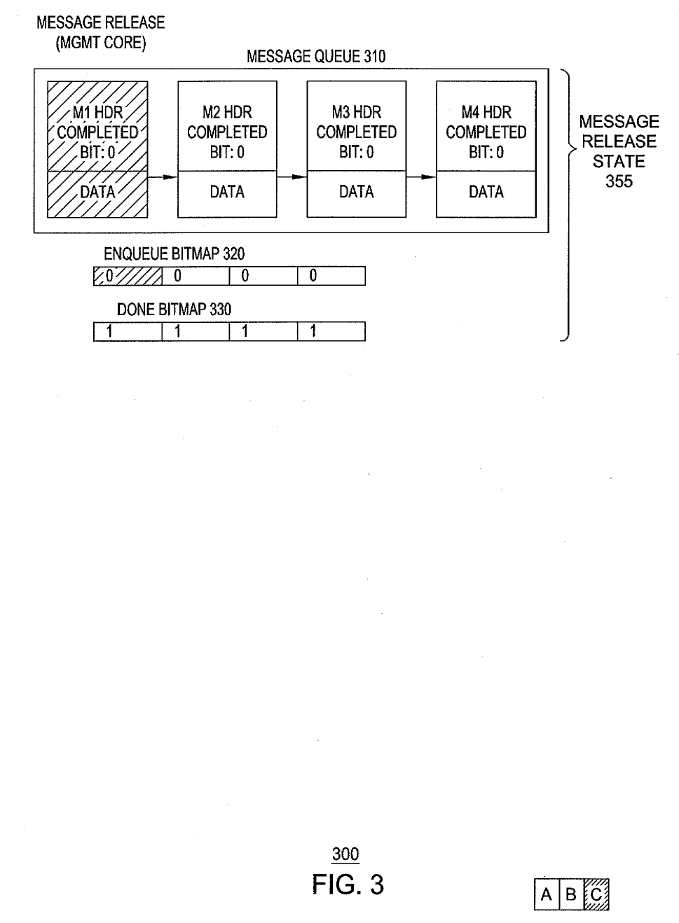

The combinations of bit values associated with the various queue states, message operations, and like features and elements of the message queuing mechanism will be understood by way of reference to FIGS. 2 and 3. It will be appreciated that combinations of such embodiments may be used for implementing different elements of the message queuing mechanism, as long as processor cores 110 are configured in a manner for understanding which combinations of bit values/states correspond to which conditions, queue states, message operations, and like.

The various message operations which may be performed using the message queuing mechanism 200 may be better understood by way of an example, which is depicted and described with respect to FIG. 3.

FIG. 3 depicts an exemplary use of the message queuing mechanism of FIG. 2 for supporting communication between the management core and one FP core of the multi-core processor of FIG. 1.

As depicted in FIG. 3, an exemplary queuing mechanism 300 is used for supporting communication between a management core and an FP core. The exemplary queuing mechanism 300 includes a message queue 310, an enqueue bitmap 320, and a done bitmap 330.

The message queue 310 includes four messages (denoted as M1-M4) and, similarly, the enqueue bitmap 320 and the done bitmap 330 each include four bit positions storing respective bits associated with the four messages, respectively.

As depicted in FIG. 3, progression of exemplary queuing mechanism 300 is illustrated as it proceeds from an initial state 351, to a state 352 in which a message write operation is performed, to a state 353 in which a message read operation is performed, to a state 354 in which a message complete operation is performed, and to a state 355 in which a message release operation is performed.

In initial state 351, the message data portions of all four messages of message queue 310 are empty, each of the four completed bits of the four messages of message queue are set to zero, each of the four bits of enqueue bitmap 320 are set to zero, and each of the four bits of done bitmap 330 are set to one, thereby indicating all four messages of message queue 310 are available for use by the management core for queuing data for processing by the FP core.

In message write state 352, a message write operation is performed by the management core. The management core receives data that needs to be processed by the FP core. The management core selects the first message M1. The management core writes data into the data portion of the first message M1, and changes the value of the first bit in enqueue bitmap from zero to one.

In message read state 353, a message read operation is performed by the FP core. The FP core is monitoring the enqueue bitmap 320 and the done bitmap 330. After the message write operation is performed, the FP core detects that, for the first message M1, the associated bit in the enqueue bitmap 320 has a value of one, the associated bit in the done bitmap 330 has a value of one, and the completed bit of the first message M1 has a value of zero. As a result, the FP core knows that the first message M1 is storing data enqueued by the management core for processing. The FP core copies the first message M1, keeps track of the bit position associated with the first message M1, and changes the value of the associated bit in the done bitmap 230 from one to zero. The FP then processes the data of the first message M1.

In message complete state 354, a message complete operation is performed by the FP core. When the FP core finishes processing the data of first message M1, the FP core communicates associated message processing results to the management core. The FP core, which at this time controls the first message M1, changes the value of the first bit of the done bitmap 330 from zero to one and changes the value of the completed bit in the header of first message M1 from zero to one, thereby indicating to the management core that processing of the data that was queued in first message M1 has been completed.

In message release state 355, a message release operation is performed by the management core. The management core is monitoring the completed bits of the messages of message queue 310, the enqueue bitmap 320, and the done bitmap 330. After the message complete operation is performed, the management core detects that, for first message M1, the associated first bit in the enqueue bitmap 320 has a value of one, the associated first bit in the done bitmap 330 has a value of one, and the completed bit of the first message M1 has a value of one. As a result, the management core knows that processing of the data queued in first message M1 is complete. The management core then changes the value of the completed bit in the message header portion of first message M1 from one to zero and changes the value of the associated first bit in the enqueue bitmap 320 from one to zero, thereby making first message M1 of the message queue 310 available for queuing new data for processing. In this case, since none of the other messages of message queue 310 have been queued with data for processing, message release state 355 is identical to initial state 351 (i.e., all four messages M1-M4 are available for receiving data written by the management core).

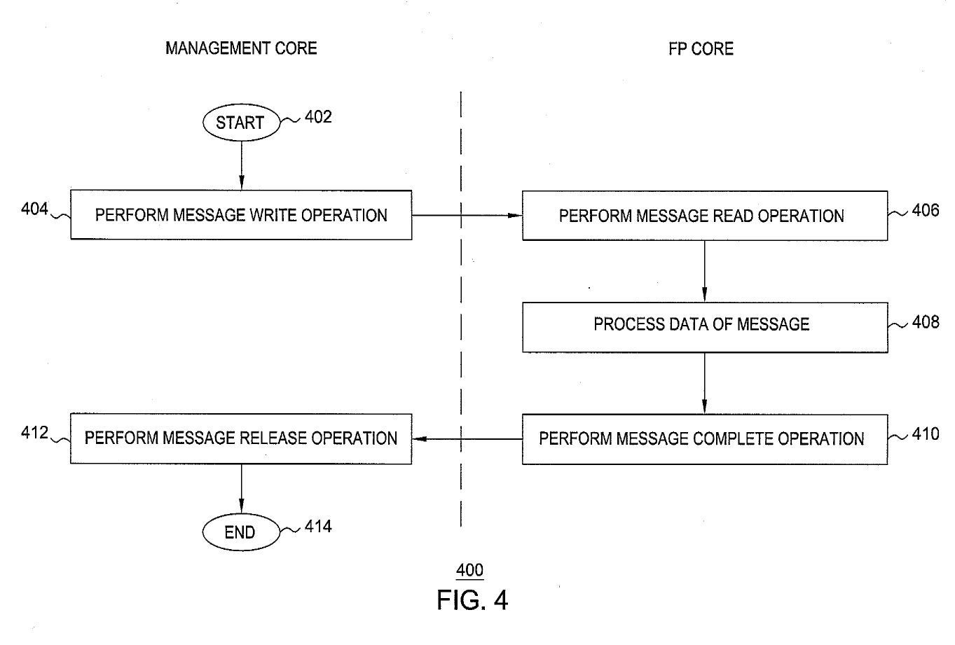

FIG. 4 depicts one embodiment of a method for using the message queuing mechanism of FIG. 2 for supporting communication between the management core and one FP core of the multi-core processor of FIG. 1.

The steps of method 400 are performed by the management core and the FP core of a multi-core processor for enabling communication between the management core and the FP core for data of a single message of a message queue. It will be appreciated that similar steps may be performed for other messages of the message queue via which the management core and the FP core communicate. Similarly, it will be appreciated that similar steps may be performed for other messages of other message queues via which the management core communicates with other FP cores.

At step 402, method 400 begins.

At step 404, the management core performs a message write operation (e.g., in a manner similar to the progression from initial state 351 to message write state 352 of FIG. 3).

At step 406, the FP core performs a message read operation (e.g., in a manner similar to the progression from message write state 352 to message read state 353 of FIG. 3).

At step 408, the FP core processes the data of the associated message of the message queue.

At step 410, the FP core performs a message complete operation (e.g., in a manner similar to the progression from message read state 353 to message complete state 354 of FIG. 3).

At step 412, the management core performs a message release operation (e.g., in a manner similar to the progression from message complete state 354 to message release state 355 of FIG. 3).

At step 414, method 400 ends.

The steps of method 400 may be better understood by way of reference to FIGS. 1-3.

Although primarily depicted and described with respect to unidirectional embodiments in which communication of data is from the management core to each of the FP cores, it will be appreciated that bidirectional embodiments may be supported in which each of the FP cores is capable of communicating data to the management core. In one such embodiment, N−1 additional message queuing mechanisms (in addition to the N−1 message queuing mechanisms depicted and described herein for unidirectional communication from the management core to each of the FP cores) may be supported for the N−1 FP cores, thereby enabling communication of data from each of the FP cores to the management core.

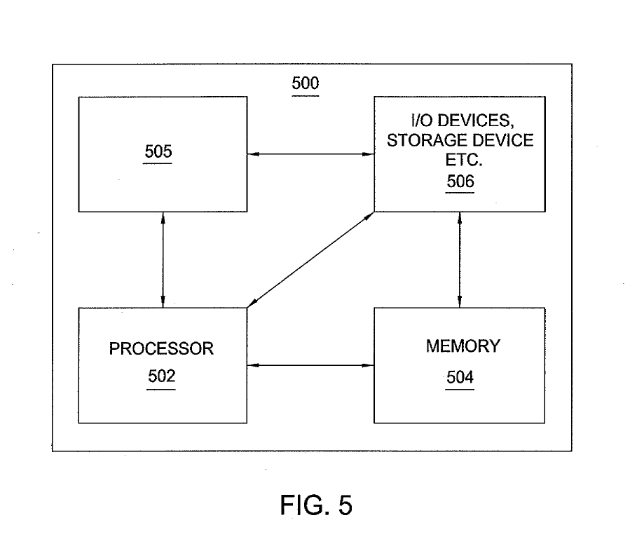

FIG. 5 depicts a high-level block diagram of a computer (computing element) suitable for use in performing various functions described herein.

As depicted in FIG. 5, computing element 500 includes various cooperating elements, including a processor element 502 (e.g., a central processing unit (CPU) and/or other suitable processor(s)), a memory 504 (e.g., random access memory (RAM), read only memory (ROM), and the like) and various input/output (I/O) devices 506 (e.g., a user input device (such as a keyboard, a keypad, a mouse, and the like), a user output device (such as a display, a speaker, and the like), an input port, an output port, a receiver/transmitter (e.g., an air card or other suitable type of receiver/transmitter), and storage devices (e.g., a hard disk drive, a compact disk drive, an optical disk drive, and the like)). FIG. 5 also depicts a cooperating element 505 that may be used to augment the functionality of the processor 502, memory 504, and/or I/O devices 506 and/or to implement any of the various or additional functions as described herein. The computer 500 depicted in FIG. 5 provides a general architecture and functionality suitable for implementing functional elements described herein or portions of functional elements described herein. For example, various embodiments of a multi-core processor as depicted and described herein with respect to FIGS. 1-4 may be used as processor 502 within the computer 500. Similarly, for example, various embodiments of a multi-core processor as depicted and described herein with respect to FIGS. 1-4 may be used as cooperating element 505 within the computer 500. For example, memory 115 of FIG. 1 may be implemented as memory 504 of FIG. 5. Various other arrangements are contemplated.

It should be noted that functions depicted and described herein may be implemented in software and/or in a combination of software and hardware, e.g., using a general purpose computer, one or more application specific integrated circuits (ASIC), and/or any other hardware equivalents. In one embodiment, software implementing methodology or mechanisms supporting the various embodiments is loaded into memory 504 and executed by processor 502 to implement the functions as discussed herein. Thus, various methodologies and functions (including associated data structures) can be stored on a computer readable storage medium, e.g., RAM memory, magnetic or optical drive or diskette, and the like.

It is contemplated that some of the steps discussed herein as software methods may be implemented within hardware, for example, as circuitry that cooperates with the processor to perform various method steps. Portions of the functions/elements described herein may be implemented as a computer program product wherein computer instructions, when processed by a computer, adapt the operation of the computer such that the methods and/or techniques described herein are invoked or otherwise provided. Instructions for invoking the inventive methods may be stored in fixed or removable media, transmitted via a data stream in a broadcast or other signal bearing medium, and/or stored within a memory within a computing device operating according to the instructions.

Although various embodiments which incorporate the teachings of the present invention have been shown and described in detail herein, those skilled in the art can readily devise many other varied embodiments that still incorporate these teachings.

What is claimed is:

1. An apparatus, comprising:
a plurality of processor cores comprising a first core and a second core; and
a message queuing mechanism configured for enabling lockless communication between the first and second cores, wherein the message queuing mechanism comprises:
a message queue comprising a plurality of messages configured for storing data queued by the first core for processing by the second core;
a first bitmap comprising a plurality of bit positions associated with respective messages of the message queue, the first bitmap configured for use by the first core to indicate availability of respective queued message data; and
a second bitmap comprising a plurality of bit positions associated with the respective messages of the message queue, the second bitmap configured for use by the second core to acknowledge availability of the respective queued message data and to indicate reception of the respective queued message data.

2. The apparatus of claim 1, wherein the first core is configured for writing data to the message queue.

3. The apparatus of claim 2, wherein the first core is configured for writing data to the message queue by:
searching the first bitmap for identifying a bit position of the first bitmap having a bit set to a first state indicative that the associated message of the message queue is available for storing the data;
writing the data into a message data portion of the message indicated by the identified bit position of the first bitmap; and
changing the bit in the identified bit position of the first bitmap from the first state to a second state indicative that data is stored within the associated message of the message queue.

4. The apparatus of claim 1, wherein the second core is configured for reading data from the message queue.

5. The apparatus of claim 4, wherein the second core is configured for reading data from the message queue by:
monitoring the message queue, the first bitmap, and the second bitmap for identifying a message of the message queue for which:
the associated bit in the first bitmap is set to a second state indicative that data is stored within the associated message of the message queue;
the associated bit in the second bitmap is set to a second state indicative that processing of the queued message data of the message is complete; and
a bit in a header portion of the message is set to a first state indicative that use of the message by the second core is not complete;
reading the queued message data of the identified message of the message queue; and
changing the bit in the identified bit position of the second bitmap from the second state to a first state indicative that processing of the queued message data of the message is not complete.

6. The apparatus of claim 5, wherein the second core is configured for reading the queued message data of the identified message of the message queue by:
copying at least the queued message data of the identified message of the message queue to a local memory of the second core.

7. The apparatus of claim 1, wherein the second core is configured for communicating, to the first core, an indication that processing of queued message data of a message of the message queue is complete.

8. The apparatus of claim 7, wherein the second core is configured for communicating, to the first core, an indication that processing of queued message data of a message of the message queue is complete by:
changing a bit in the associated bit position of the second bitmap from a first state indicative that processing of the queued message data of the message is not complete to a second state indicative that processing of the queued message data of the message is complete; and
changing a bit in a header portion of the message from a first state indicative that use of the message by the second core is not complete to a second state indicative that use of the message by the second core is complete.

9. The apparatus of claim 1, wherein the first core is configured for releasing a message of the message queue for making the message available for storing new data.

10. The apparatus of claim 9, wherein the first core is configured for releasing a message of the message queue for making the message available for storing new data by:
monitoring the message queue, the first bitmap, and the second bitmap for identifying a message of the message queue for which:
the associated bit in the first bitmap is set to a second state indicative that data is stored within the associated message of the message queue;
the associated bit in the second bitmap is set to a second state indicative that processing of the queued message data of the message by the second core is complete; and
a bit in a header portion of the message is set to a second state indicative that use of the message by the second core is complete; and
changing the associated bit in the first bitmap from the second state indicative that data is stored within the associated message of the message queue to a first state indicative that the associated message of the message queue is available for storing data; and
changing the associated bit in the header portion of the message from the second state indicative that use of the message by the second core is complete to a first state indicative that use of the message by the second core is not complete.

11. The apparatus of claim 1, wherein the second core is configured for processing data read from a message of the message queue to produce thereby a data processing result, wherein the second core is configured for communicating the data processing result to the first core.

12. The apparatus of claim 1, wherein the first core is a management core and the second core is a processing core.

13. A method for supporting communication between a first core and a second core of a multi-core processor, the method comprising:
communicating data from the first core to the second core using a message queuing mechanism, wherein the message queuing mechanism comprises:
a message queue comprising a plurality of messages configured for storing data queued by the first core for processing by the second core;
a first bitmap comprising a plurality of bit positions associated with respective messages of the message queue, the first bitmap configured for use by the first core to indicate availability of respective queued message data; and
a second bitmap comprising a plurality of bit positions associated with the respective messages of the message queue, the second bitmap configured for use by the second core to acknowledge availability of the respective queued message data and to indicate reception of the respective queued message data.

14. The method of claim 13, wherein communicating data from the first core to the second core using a message queuing mechanism comprises writing data to the message queue, wherein the data is written by the first core.

15. The method of claim 14, wherein writing data to the message queue comprises:
searching the first bitmap for identifying a bit position of the first bitmap having a bit set to a first state indicative that the associated message of the message queue is available for storing the data;
writing the data into a message data portion of the message indicated by the identified bit position of the first bitmap; and
changing the bit in the identified bit position of the first bitmap from the first state to a second state indicative that data is stored within the associated message of the message queue.

16. The method of claim 13, wherein communicating data from the first core to the second core using a message queuing mechanism comprises reading data from the message queue, wherein the data is read by the second core.

17. The method of claim 16, wherein reading data from the message queue comprises:
monitoring the message queue, the first bitmap, and the second bitmap for identifying a message of the message queue for which:
the associated bit in the first bitmap is set to a second state indicative that data is stored within the associated message of the message queue;
the associated bit in the second bitmap is set to a second state indicative that processing of the queued message data of the message is complete; and
a bit in a header portion of the message is set to a first state indicative that use of the message by the second core is not complete;
reading the queued message data of the identified message of the message queue; and
changing the bit in the identified bit position of the second bitmap from the second state to a first state indicative that processing of the queued message data of the message is not complete.

18. The method of claim 17, wherein reading the queued message data of the identified message of the message queue comprises:
copying at least the queued message data of the identified message of the message queue to a local memory of the second core.

19. The method of claim 13, further comprising:
processing, by the second core, queued message data of a message of the message queue; and
communicating, by the second core to the first core, an indication that processing of queued message data of the message of the message queue is complete.

20. The method of claim 19, wherein communicating, by the second core to the first core, an indication that processing of queued message data of the message of the message queue is complete comprises:
changing a bit in the associated bit position of the second bitmap from a first state indicative that processing of the queued message data of the message is not complete to a second state indicative that processing of the queued message data of the message is complete; and
changing a bit in a header portion of the message from a first state indicative that use of the message by the second core is not complete to a second state indicative that use of the message by the second core is complete.

21. The method of claim 13, further comprising:
releasing, by the first core, a message of the message queue for making the message available for storing new data.

22. The method of claim 21, wherein releasing a message of the message queue for making the message available for storing new data comprises:
monitoring the message queue, the first bitmap, and the second bitmap for identifying a message of the message queue for which:
the associated bit in the first bitmap is set to a second state indicative that data is stored within the associated message of the message queue;
the associated bit in the second bitmap is set to a second state indicative that processing of the queued message data of the message by the second core is complete; and
a bit in a header portion of the message is set to a second state indicative that use of the message by the second core is complete; and
changing the associated bit in the first bitmap from the second state indicative that data is stored within the associated message of the message queue to a first state indicative that the associated message of the message queue is available for storing data; and
changing the associated bit in the header portion of the message from the second state indicative that use of the message by the second core is complete to a first state indicative that use of the message by the second core is not complete.

23. The method of claim 13, wherein the second core is configured for processing data read from a message of the message queue to produce thereby a data processing result, wherein the second core is configured for communicating the data processing result to the first core.

24. The method of claim 13, wherein the first core is a management core and the second core is a processing core.
